(19) United States
(12) Patent Application Publication
(10) Pub. No.: US 2008/0180826 A1
(43) Pub. Date: Jul. 31, 2008

(54) METHOD FORMING SERVO SYNC MARK PATTERNS AND PREVENTING WRITE FAULTS IN HARD DISK DRIVE

(75) Inventor: Jae-deog CHO, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Gyeonggi-do (KR)

(21) Appl. No.: 11/841,059

(22) Filed: Aug. 20, 2007

(30) Foreign Application Priority Data
Jan. 26, 2007 (KR) 10-2007-0008615

(51) Int. Cl. G11B 5/09

(52) U.S. Cl. 360/48

(57) ABSTRACT

A method of forming a servo sync mark patterns on a disk is disclosed wherein alternating even-numbered and odd-numbered tracks are marked with a first servo sync mark pattern on the even-numbered tracks, and a second servo sync mark pattern, different from the first servo mark pattern, on the odd-numbered tracks. A write operation is controlled in an HDD in relation to either a first sync mark pattern or a second sync mark pattern read from a servo region of a current track and an expected sync mark pattern associated with a target track indicated by the write operation.

### CROSS-REFERENCE TO RELATED PATENT APPLICATION

This application claims the benefit of Korean Patent Application No. 10-2007-0008615, filed on Jan. 26, 2007, the subject matter of which is hereby incorporated by reference.

### BACKGROUND OF THE INVENTION

1. Field of the Invention

The present invention relates to a method and apparatus for writing data in a hard disk drive. More particularly, the invention relates to a method of respectively forming different servo sync patterns in even-numbered and odd-numbered disk to prevent a write fault, and a hard disk drive using same.

2. Description of the Related Art

Figure (FIG.) 1 illustrates a configuration of a conventional hard disk drive 100. Referring to FIG. 1, the hard disk drive 100 includes at least one disk 112 rotating by a spindle motor 114 and a head 120 placed in close proximity to the surface of the disk 112. Those of ordinary skill understand that the term “head” may be used to indicate one or more physical elements adapted to read data from and write data to a disk. The head 120 senses a magnetic field formed on the surface of the disk 112 or magnetizes the surface of the disk 112 to read or write information from or to the rotating disk 112. The head 120 is constructed such that an air bearing is generated between the head 120 and the surface of the disk 112. The head 120 and a head stack assembly (HSA) 122 are attached to an actuator arm 124 having a voice coil 126. The voice coil 126 is located in close proximity to a magnetic assembly 128 that supports a voice coil motor 130. The actuator arm 124 rotates to move the head 120 across the surface of the disk 112. Data is stored in a track of the disk 112 by the moved head 120.

FIG. 2A conceptually illustrates a portion of an exemplary disk track 134. Referring to FIG. 2A, the track 134 includes alternating servo regions 201 and data regions 203. The servo regions 201 store information indicating the position of the corresponding track. Thus, the position of the track 134 can be detected by reading the information stored in the servo regions 201. The data regions 203 store data.

The head is moved to a predetermined track on the disk 112 using the voice coil motor 130 under the control of a controller (not shown). Then, the head reads servo information recorded in the servo regions 201 of the track and determines whether the track corresponds to a target track in which data will be stored. When the track corresponds to the intended target track, the head writes the data to the data regions 203 of the corresponding track.

FIG. 2B illustrates the servo regions 201 of FIG. 2A in some additional detail. Referring to FIG. 2B, each servo region 201 includes a preamble 251, a servo sync mark (SAM/SIM) pattern, a gray code 255, and a servo burst 257.

The preamble 251 indicates the beginning of a particular servo region 201 and creates a gap prior to other servo sector data facilitating proper timing margins. For example, in the illustrated example, a synchronization signal generated in synchronization with a defined clock frequency. Automatic gain control (AGC) may also be determined an amplification gain factor.

The servo sync mark pattern 253 is composed of a servo address mark (SAM) pattern or a servo index mark (SIM) pattern. The SIM pattern is formed in a servo region placed at a first sector of a track and provides information about one-rotation of a disk. The SAM pattern is formed in servo regions other than the servo region located at the first sector of the track and represents the start of a servo sector. For example, when a single track includes 200 servo regions, the SIM pattern is formed in a first servo region and SAM patterns are formed in the second through the 200th servo regions.

In a conventional disk, a servo sync mark pattern (SIM/SAM) is commonly for all tracks of the disk. That is, respective first servo regions for each track have the same SIM pattern, and all servo regions other than respective first servo regions for each track have the same SAM pattern.

The gray code 255 provides a track number and a sector number. The servo burst 257 provides information used to control the head to be located at the center of the track to trace the track. The servo burst 257 formed from a combination of patterns A, B, C and D is analyzed to generate a position error signal (PES) having information about the position of the track. Accordingly, the correct position of the track in the disk can be recognized using the servo burst 257.

FIG. 3A illustrates a normal data writing operation. The head 120 traces a designated track and confirms whether the track on which the head is currently placed corresponds to a target track to which data will be written. Then, the head 120 writes data transmitted through a pre-amplifier to a data region of the track. The head 120 reads and analyzes the preamble 152, the servo sync mark pattern (SAM/SIM) 253, the gray code 255 and the servo burst 257 illustrated in FIG. 2B while passing through servo regions.

To write data, the head 120 must arrive at a desired position on the track. Accordingly, the head 120 is moved to a servo region of the track and reads the servo sync mark pattern 253 that represents the start position of servo information and the gray code 255 that represents the position of a servo track to confirm the position of the track. Then, the head 120 reads the servo burst 257 and generates the PES that represents a degree to which the head deviates from the target track. Accordingly, it can be confirmed that the head is correctly located on the target track to which the data will be written.

Finally, a write fault signal having information about whether the data is written to the track is output in response to the result of the operation of reading the preamble, the servo sync mark pattern, the gray code and the servo burst. When it is determined that the head is located on the right track, the head continuously traces the track and writes the data in the data regions 203, as illustrated in FIG. 2A.

FIG. 3A illustrates a case in which the head traces the right track and thus a “normal” write operation is carried out. The write operation is executed in response to a write gate signal WG applied by a controller (not shown). The data is written in a period during which the write gate signal WG is enabled. Here, the enabled period for the write gate signal WG corresponds to logically high signal value and the disabled period for the write gate signal WG corresponds to logically low signal value.

FIG. 3B illustrates a data writing operation in which a write fault is generated. Under certain well understood conditions a disk within a hard disk drive may vibrate or oscillate as it is turned by a spindle motor. Such oscillation may cause unstable servo positioning. Alternately, instabilities associated with movement of the head 120 may cause the head 120 to skip into a neighboring track. Under these and other ill-influences, a write fault may be generated.

In one example of this problem, it is assumed that Track N is designated as a target track for a write operation. However, the head 120 operates somewhat unstably and instead skips to a neighboring Track (N+1). As a result, instead of positioning the head 120 over a servo region 331 of Track N, head 120 skips to position over a data region 337 of Track (N+1).

In this errant position, head 120 attempts to read information (e.g., preamble 251, servo sync mark pattern 253, gray code 255 and servo burst 257) recorded in the servo region 331. A controller outputs a disabled value for the write fault signal WF when head 120 is correctly located over the designated target track (e.g., Track N in the example). The controller makes this determination on the basis of information read from servo region 331 before the write operation illustrated in FIG. 3A is performed. In contrast, the controller outputs an enabled value for the write fault signal WF when head 120 is not located over the designated target track. When an output write fault signal WF is in an enabled state, the write gate signal WG is disabled. Accordingly, the write operation is stopped.

During the conventional write operation, it is determined whether head 120 is located over a designated target track by reading all of the information contained in a corresponding servo region (i.e., preamble 251, servo sync mark pattern 253, gray code 255 and servo burst 257 data). Accordingly, a write fault signal value determination may only be started after the servo region read operation has been completed. In some instances, this determination may take so long that before it is finished, a write operation has already begun relative to an errant data region (e.g., data region 337 in the illustrated example).

Thus, in a case where the target track indicated for a write operation turns out to be different from the actual track over which a write head is positioned, when all the servo control information, such as servo track information, PES and so on, is finally read, and thereafter it is determined whether the write operation should continue, the write operation has already started and thus the write fault signal WF is enabled after a predetermined lapse of time.

When an enabled write fault signal WF (i.e., a logically high signal) is applied while the write operation is being carried out, the write operation is stopped. Thereafter, the disk is rotated around so that the data may be written to the proper target track. However, any data erroneously written to the errant data region 337 of Track (N+1) is not erased. Although correct data is ultimately written to the data region 335 of the target Track N by a corrected write operation, the data erroneously written to the data region 337 of Track (N+1) remains. As a result, a write fault is generated relative to the data region 337 of Track (N+1), and data previously written to the data region 337 is destroyed.

### SUMMARY OF THE INVENTION

Embodiments of the present invention provide a method of forming servo sync mark patterns that better immunize a hard disk drive from write faults. Embodiments of the invention also provide a method of preventing write faults, and a hard disk drive incorporating same.

In one embodiment, the invention provides a method of forming a servo sync mark patterns on a disk including alternating even-numbered and odd-numbered tracks, the method comprising; forming a first servo sync mark pattern on the even-numbered tracks, and forming a second servo sync mark pattern, different from the first servo mark pattern, on the odd-numbered tracks.

In another embodiment, the invention provides a method of preventing a write fault during execution of a write operation directed to a disk having even-numbered tracks with a first servo sync mark pattern, and odd-numbered tracks with a second servo sync mark pattern different from the first servo sync mark pattern, the method comprising; reading a servo region associated with a current track over which a head is positioned, determining in relationship to either a first sync mark pattern or a second sync mark pattern read from the servo region whether the current track is a target track indicated by the write operation, and if the current track is the target track, performing the write operation in relation to a corresponding data region of the current track, else outputting an enabled write fault signal.

In another embodiment, the invention provides a hard disk drive (HDD) comprising; a head writing data to a disk and reading data from the disk, the disk having even-numbered tracks with a first servo sync mark pattern, and odd-numbered tracks with a second servo sync mark pattern different from the first servo sync mark pattern, a voice coil motor driving the head, and a controller positioning the head over the disk during read and write operations and controlling execution of write operations in relation to either a first sync mark pattern or a second sync mark pattern read from a servo region of a current track over which the head is positioned and an expected sync mark pattern associated with a target track indicated by the write operation.

### BRIEF DESCRIPTION OF THE DRAWINGS

Embodiments of the invention will be described with reference to the attached drawings in which:

FIG. 1 illustrates a configuration of a conventional hard disk drive;

FIG. 2A illustrates a track of a disk;

FIG. 2B illustrates a servo region illustrated in FIG. 2A in more detail;

FIG. 3A illustrates a normal write operation;

FIG. 3B illustrates a write operation in which a write fault is generated;

FIG. 4A is a flow chart of a method of preventing a write fault according to an embodiment of the present invention;

FIG. 4B illustrates a disk on which different servo sync patterns are formed according to an embodiment of the present invention;

FIG. 4C illustrates a data writing operation according to the method illustrated in FIG. 4A; and

FIG. 5 is a block diagram of a hard disk drive according to an embodiment of the present invention.

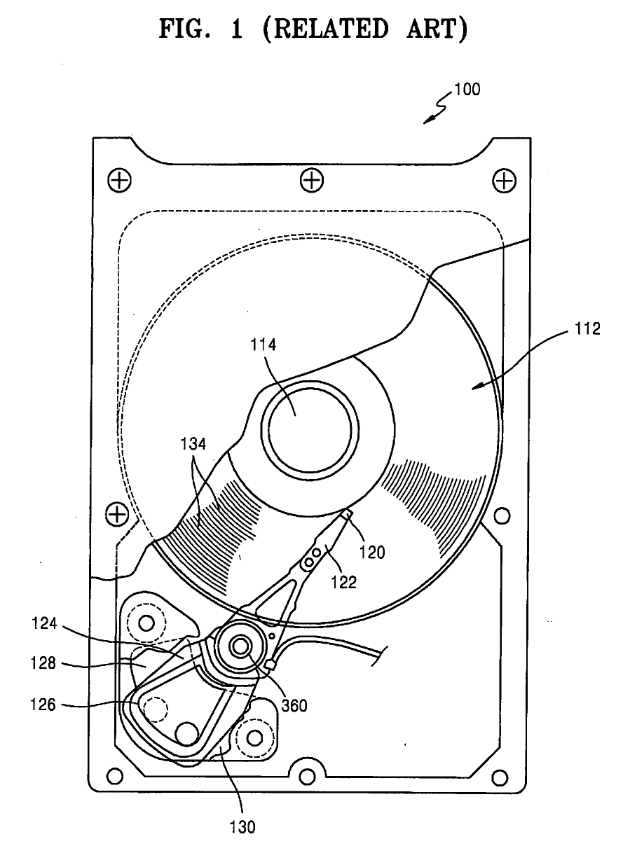

### DESCRIPTION OF EMBODIMENTS

Embodiments of the invention will now be described more fully with reference to the accompanying drawings. The invention may, however, be embodied in many different forms and should not be construed as being limited to only the illustrated embodiments. Rather, these embodiments are presented as teaching examples. Throughout the written description and drawings, like reference numerals refer to like or similar elements.

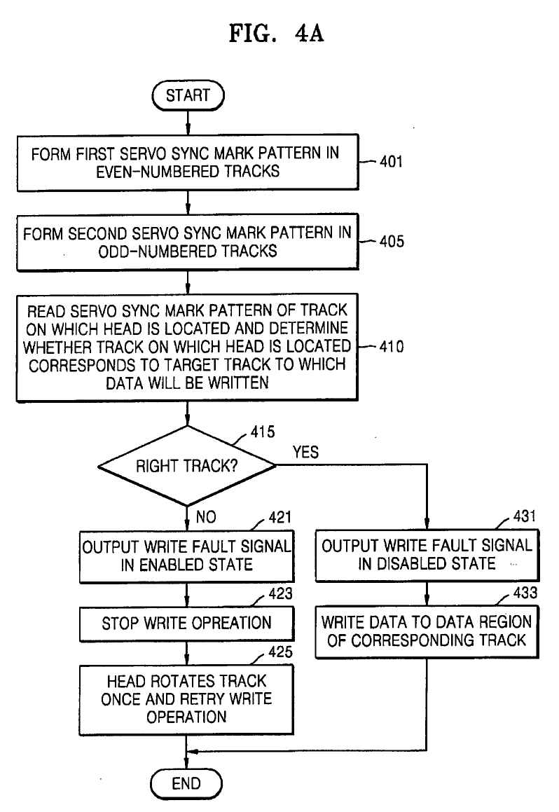

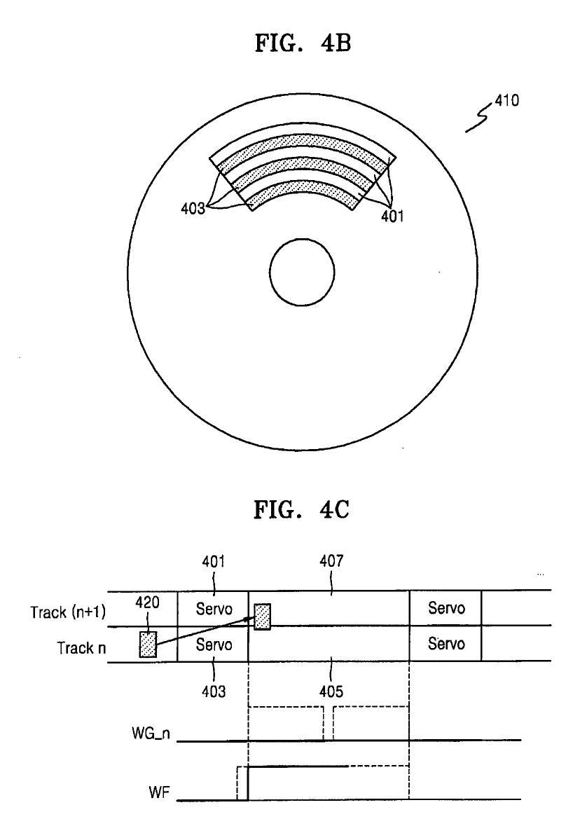

FIG. 4A is a flow chart summarizing a method of preventing a write fault according to an embodiment of the invention. Referring to FIG. 4A, a first servo sync mark pattern is formed in even-numbered tracks of a disk (401), and then a second servo sync mark pattern is formed in odd-numbered tracks of the disk (405). The first servo sync mark pattern is different from the second servo sync mark pattern.

The servo sync mark pattern of a track on which a head is located is read to determine whether the head is located on a target track to which data will be written (410). Here, the track has the first servo sync mark pattern when it is an even-numbered track and the track has the second servo sync mark pattern when it is an odd-numbered track.

When a target track to which data will be written is an even-numbered track, it is determined that the head is located on the right track when the first servo sync mark pattern is read. When the designated track to which data will be written is an odd-numbered track, it is determined that the head is located on the right track when the second servo sync mark pattern is read. When the second servo sync mark pattern is read while the target track is an even-numbered track, it is determined that the head is errantly located on a wrong track.

When the head is located on a wrong track, a write fault signal is output in an enabled state (421). The write fault signal includes information indicating whether the head is located over a target track. When the write fault signal is output in a disabled state, the head is correctly located over the target track, but when the write fault signal is output in an enabled state, the head is errantly located over a different track (i.e., a track other than the designated target track).

Specific signal forms and corresponding logic levels for the write fault signal are a matter of design choice. However, in the illustrated embodiment, the enabled state corresponds to a logically high value and the disabled state corresponds to logically low value.

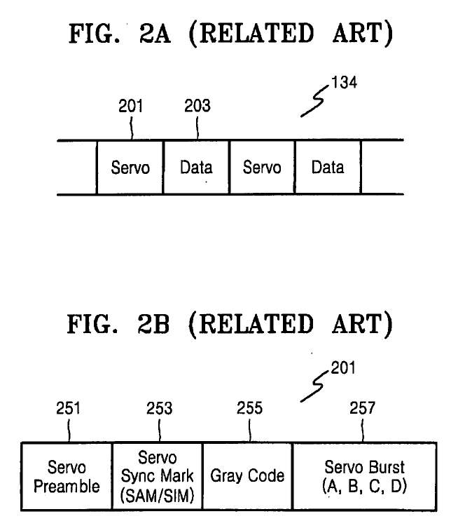

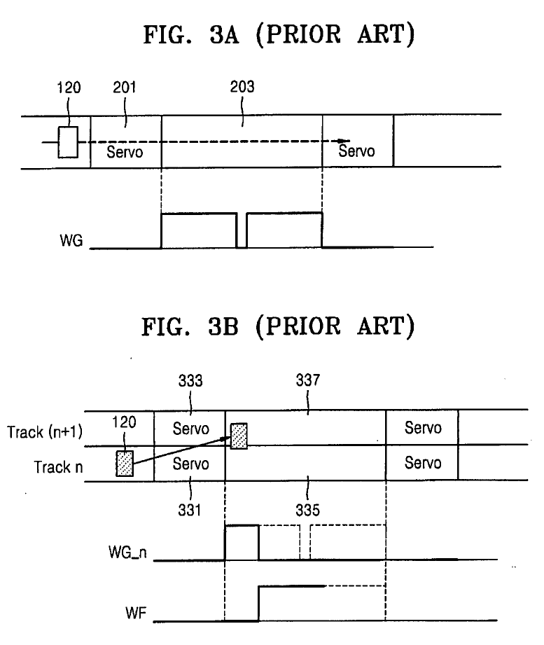

The servo sync mark pattern is formed at a “front portion” of a corresponding servo region, as illustrated in FIG. 2B, and read operations associated with the servo region may detect a particular sync mark pattern as a head passes “through” (i.e., passes over the length of) the beginning portions of the servo region. In one embodiment of the invention, the respective first or second servo sync mark pattern may be formed between a preamble and a gray code of a servo region and may be formed as a servo index mark (SIM) pattern or a servo address mark (SAM) pattern.

Accordingly, a write fault signal may be output at a point in time before the head passes through the entire servo region. The actual delay period between beginning a servo region read operation and output of a competent write fault signal is a matter of design choice, as is the exact placement of the sync mark pattern within the servo region. However, such design choices should nonetheless ensure that a competent write fault signal is output before the head finishes reading all of the other information contained in the servo region.

Returning to the flowchart of FIG. 4A, when an enabled write fault signal is output (421) following an indication of errant track positioning (415=no), an ongoing data write operation is stopped (423). That is, the preparatory operations associated with the execution of a write operation are interrupted before the head finishes passing through the servo region and before actual data writing occurs in the current data region (i.e., a data region associated with a “current track” over which the head is positioned as it reads the current servo region).

Following interruption of the ongoing write operation (421), the disk is rotated and the head re-positioned in order to perform a re-try write operation directed to the originally intended target track (425). With positive indication of the target track and successful execution of the re-try write operation, the write operation is complete and ends.

However, when a disabled write fault signal is output (431) following an indication of proper track positioning (415=yes), the ongoing data write operation is executed in a corresponding data region(s) (433).

The foregoing method embodiment better immunizes the hard disk drive from write faults since a competent write fault signal is output before the head enters a data region of the current track, and before data is written to the data region. In this manner, data will not be errantly written to a track neighboring a designated target track. Instead, errant poisoning of the head over the neighboring track will be detected well before the actual writing of data.

FIG. 4B illustrates a disk on which different servo sync mark patterns are formed according to an embodiment of the present invention. Referring to FIG. 4B, tracks 401 are even-numbered tracks and tracks 403 are odd-numbered tracks. The first servo sync mark pattern is formed in the even-numbered tracks 401 and the second servo sync mark pattern is formed in the odd-numbered tracks 403, as described above. When the head is errantly positioned over a neighboring track, it will quickly (i.e., early in the read process of the servo region) detect a servo sync mark pattern different from the servo sync mark pattern expected for the target track (i.e., odd verses even servo sync marks).

FIG. 4C further illustrates a write operation according to the method embodiment illustrated in FIG. 4A. Referring to FIG. 4C, a target Track N is designated in relation to an ongoing write operation. However, a head 420 is errantly moved over a current Track (N+1) neighboring target Track N due to some head oscillation, mechanical vibration, servo in stability, etc. As a result, head 420 begins reading data from a servo region 401 associated with current Track (N+1). At a front portion of servo region 401 (i.e., a portion of servo region 401 read relatively early in the servo region read operation), a servo sync mark pattern is recorded in relation to current Track (N+1). Since the servo sync mark pattern read from the current Track (N+1) is different from the servo sync mark pattern expected for the target Track N, an enabled write fault signal is output before head 420 passes completely through servo region 401 and before actual write operations are performed in data region 407. When an enabled write fault signal is output, a write gate signal WG_n controlling the actual execution of the ongoing write operation stays low and the write operation is not carried out.

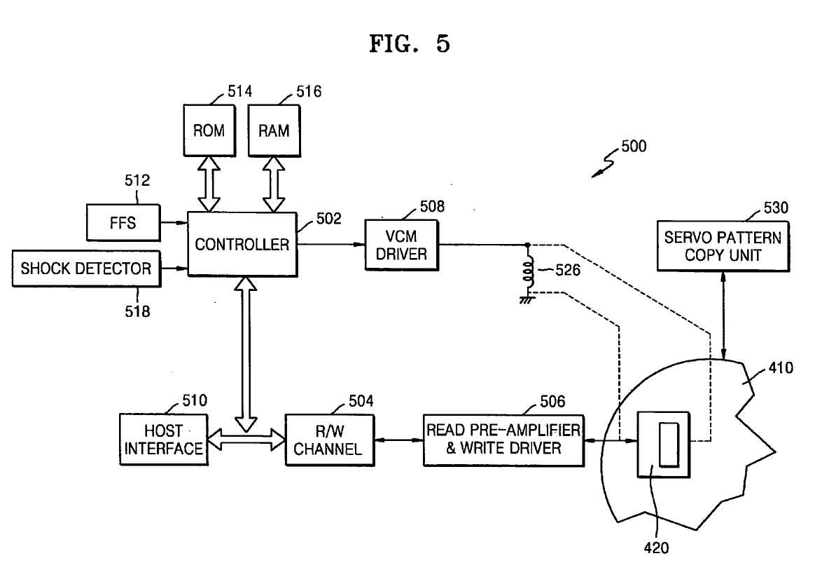

FIG. 5 is a block diagram of a hard disk drive (HDD) 500 according to an embodiment of the invention. HDD 500 generally includes an HDD control unit and an HDD driver. The HDD control unit includes a controller 502 as its main component and the HDD driver includes a voice coil motor (VCM) 526 and a VCM motor driver 508 as its main components.

The HDD control unit includes a read/write (R/W) channel 504, a read pre-amplifier & write driver 506, and the controller 502. The controller 502 uses a digital signal processor, a micro-processor or a micro-controller. The controller 502 controls an operation of reading data from a disk 410 and an operation of writing data to the disk 410. Accordingly, the controller 502 provides a control signal for reading or writing data to the R/W channel 504.

The data read from the disk 410 is transmitted to a host interface circuit 510 through the R/W channel 504. The host interface circuit 510 includes a control circuit for interfacing with a system such as a personal computer.

The R/W channel 504 modulates an analog signal read by a head 420 and amplified by the read pre-amplifier & write driver 506 into a digital signal readable by a host computer (not shown) and outputs the digital signal to the host interface circuit 510. In addition, the R/W channel 504 receives data from the host computer through the host interface circuit 510, converts the data into a current signal recordable on the disk 410 and outputs the current signal to the read pre-amplifier & write driver 506.

The controller 502 is connected to the VCM driver 508 that supplies a driving current to the VCM 526, and thus the controller 502 provides a control signal for controlling the operation of the VCM 526 and the movement of the head 420 to the VCM driver 508.

A read only memory (ROM) 514 and a random access memory (RAM) 516 store software routines and data used by the controller 501 to control the hard disk drive 500. The software routines include the software routine corresponding to the method of preventing a write fault illustrated in FIG. 4A. The controller 502 executes the method of preventing a write fault according to the operations illustrated in FIG. 4A.

Specifically, the controller 502 receives a servo sync mark pattern read from the disk 410 and determines whether the head 420 is located on the right track. When the head 420 is located on the right track, the controller 502 controls data to be written to the track. When the head 420 is not located on the right track, the controller 502 controls the data not to be written to the track. The control operation of the controller 502 corresponds to the method of preventing a write fault illustrated in FIG. 4A so that detailed explanation thereof is omitted.

The disk 410 is a data storage medium. The disk 410 included in the hard disk drive 500 according to embodiments of the invention has different servo sync mark patterns for even-numbered tracks and odd-numbered tracks. That is, the first servo sync mark pattern is formed in the even-numbered tracks while the second servo sync mark pattern is formed in the odd-numbered tracks.

The hard disk drive 500 may further include a servo copy unit 530 that forms the first or second servo sync mark pattern in servo regions of the disk 410. The servo sync mark pattern can be formed using the servo copy unit 530 included in the hard disk drive 500 or using a separate device such as a servo write device. It will be understood by those of ordinary skill in the art that the servo write device forms the servo sync mark pattern using an empty disk and a reference pattern.

The servo copy unit 530 copies a seed pattern stored therein to the servo regions of the disk 410 to form the servo sync mark pattern. The seed pattern includes the first servo sync mark pattern and the second servo sync mark pattern different from the first servo sync mark pattern. This may be controlled by software. The servo copy unit 530 respectively forms the first and second servo sync mark patterns in the even-numbered tracks and the odd-numbered tracks of the disk 410.

As described above, a write method that reduces write faults according to embodiments of the invention respectively forms different servo sync mark patterns in even-numbered and odd-numbered tracks of a disk to prevent data from being written to a neighboring track while the head is errantly positioned. Furthermore, a hard disk drive better immunized from write faults according to embodiments of the invention will include hardware and software resources capable of implementing this write method.

While the present invention has been particularly shown and described with reference to exemplary embodiments thereof, it will be understood by those of ordinary skill in the art that various changes in form and details may be made therein without departing from the scope of the present invention as defined by the following claims.

What is claimed is:

1. A method of forming a servo sync mark patterns on a disk including alternating even-numbered and odd-numbered tracks, the method comprising:
forming a first servo sync mark pattern on the even-numbered tracks; and
forming a second servo sync mark pattern, different from the first servo mark pattern, on the odd-numbered tracks.

2. The method of claim 1, wherein the first and second servo sync mark patterns are respectively formed at front portions of a corresponding servo regions for the odd-numbered and even-numbered tracks.

3. The method of claim 2, wherein the first and second servo sync mark patterns are respectively formed between a preamble and a gray code of the corresponding servo region, and are formed as a servo index mark (SIM) pattern or a servo address mark (SAM) pattern.

4. A method of preventing a write fault during execution of a write operation directed to a disk having even-numbered tracks with a first servo sync mark pattern, and odd-numbered tracks with a second servo sync mark pattern different from the first servo sync mark pattern, the method comprising:
reading a servo region associated with a current track over which a head is positioned;
determining in relationship to either a first sync mark pattern or a second sync mark pattern read from the servo region whether the current track is a target track indicated by the write operation; and
if the current track is the target track, performing the write operation in relation to a corresponding data region of the current track, else outputting an enabled write fault signal.

5. The method of claim 4, wherein reading the servo region comprises passing the head through the servo region and the determination of whether the current track is the target track is made before the head passes completely through the servo region.

6. The method of claim 5, wherein if the current track is the target track, the method further comprises outputting a disabled write fault signal.

7. The method of claim 6, further comprising; stopping the write operation in response to the enabled write fault signal.

8. The method of claim 7, further comprising:
after stopping the write operation, performing a re-try write operation in relation to the target track by rotating the disk and re-positioning the head.

9. The method of claim 4, wherein at least one of the first and second servo sync mark patterns is formed between a preamble and a gray code of servo regions corresponding respectively to the odd-numbered tracks and the even-numbered tracks, and the at least one of the first and second servo sync mark patterns is formed as an SIM pattern or an SAM pattern.

10. The method of claim 4, wherein at least one of the first and second servo sync mark patterns contains information related to rotation of the disk, or the start of a servo sector.

11. A hard disk drive (HDD) comprising:
a head writing data to a disk and reading data from the disk, the disk having even-numbered tracks with a first servo sync mark pattern, and odd-numbered tracks with a second servo sync mark pattern different from the first servo sync mark pattern;
a voice coil motor driving the head; and
a controller positioning the head over the disk during read and write operations and controlling execution of write operations in relation to either a first sync mark pattern or a second sync mark pattern read from a servo region of a current track over which the head is positioned and an expected sync mark pattern associated with a target track indicated by the write operation.

12. The HDD of claim 11, wherein the controller outputs a disabled write fault signal when the first or second sync mark pattern read from the servo sector corresponds with the expected sync mark pattern associated with the target track, and outputs an enabled write fault signal when the first or second sync mark pattern read from the servo sector does not correspond with the expected sync mark pattern associated with the target track.

13. The HDD of claim 11, wherein operation of the voice coil motor is controlled in relation to the write fault signal.

14. The HDD of claim 11, wherein at least one of the first and second servo sync mark patterns is formed between a preamble and a gray code of servo regions corresponding respectively to the odd-numbered tracks and the even-numbered tracks, and the at least one of the first and second servo sync mark patterns is formed as an SIM pattern or an SAM pattern.

15. The HDD of claim 14, wherein at least one of the first and second servo sync mark patterns contains information related to rotation of the disk, or the start of the servo sector.
